(19) United States
(12) Patent Application Publication
(10) Pub. No.: US 2014/0001674 A1
(43) Pub. Date: Jan. 2, 2014

(54) MANUFACTURING METHOD FOR A HINGE

(71) Applicant: Lee-Yeh Lu, New Taipei City (TW)

(72) Inventor: Lee-Yeh Lu, New Taipei City (TW)

(21) Appl. No.: 13/535,926

(22) Filed: Jun. 28, 2012

(51) Int. Cl. B29C 45/14

(52) U.S. Cl. 264/255

(57) ABSTRACT

A manufacturing method for a hinge has steps of forming one of a central element and a surrounding element by injection molding, cooling down the formed element, and forming the other element on the priorly-formed element by injection molding such that a limit segment of the surrounding element is mounted around the neck segment, which keeps the surrounding element from departing axially from the central element, and further simplifies a structure of the hinge. Because a melting point of the element formed priorly is higher than a melting point of the element formed later, the element formed later does not attach to the element formed priorly. Therefore, the two elements are relatively rotatable. Finally, because a manufacturing process is accomplished after injection molding twice, the process is more convenient and faster, and the cost is lowered.

### BACKGROUND OF THE INVENTION

1. Field of the Invention

The present invention relates to a manufacturing method for a hinge, especially to a manufacturing method for a hinge that is mounted between the cover and the base of a flip device.

2. Description of the Prior Arts

Hinge is a device to rotate two objects relatively, and is usually used in flip devices, such as notebook computers. Two ends of the hinge are respectively connected securely to the base and the cover of the notebook computer. Then the cover can be opened or closed relative to the base.

A conventional hinge has a central element, a surrounding element and a fastener. The surrounding element is mounted rotatably around the central element. The fastener is mounted on an end of the central element. The surrounding element is clamped between the fastener and the central element, which keeps the surrounding element from departing axially from the central element. When the hinge is used, the central element and the surrounding element are respectively connected securely to two objects, which are to rotate relatively.

The conventional hinge only can allow two objects to rotate relative to each other. For achieving more functions, the conventional hinge usually comprises other elements such as a convex and concave washer assembly. The convex and concave washer assembly has two actuating washers and a spring. The actuating washers have corresponding shapes. The actuating washers and the spring are mounted around the central element. One of the actuating washers is connected securely to the central element, and the other one of the actuating washers is connected securely to the surrounding element. The spring makes the actuating washers abut each other. Normally, the actuating washers engage each other, but once the surrounding element and the central element are rotated relatively by an external force, the actuating washers rotate relatively as well. Then the actuating washers disengage from each other, and compress the spring therefore. When the external force is removed, the spring then pushes one of the actuating washers to make the actuating washers recovered to engage each other. As a result, when the actuating washers engage each other, the two objects are held at a specific angle, such as 90 degrees.

The conventional manufacturing method for the hinge comprises:

Making the components. The central element, the surrounding element and the fastener are made, and the process may comprise cold drawing, forging, turning, heat treatment, surface treating and so on.

Assembling the components. The surrounding element is mounted around the central element. Then the fastener is mounted on an end of the central element, and the fastener and the central element clamp the surrounding element. The fastener may be a nut and is screwed onto the end of the central element. However, because the nut is usually screwed tightly to prevent the nut from being loosened, the hinge has to further comprise an abrasion washer to reduce the abrasion, or the nut has to be glued to the central element.

To sum up, making each component takes much time and effort, and the subsequent assembling work is also complicated. Besides, the above-mentioned conventional manufacturing method is merely described in brief for illustrative purpose. In practice, the hinge may further comprise other components, such as a convex and concave washer assembly. Then the assembling takes more time and efforts, and the cost is increased therefore. Moreover, the conventional hinge comprises many components such that the connection between the components of the conventional hinge is not stable enough. Finally, the conventional hinges are mostly made of metal, which also costs a lot.

To overcome the shortcomings, the present invention provides a manufacturing method for a hinge to mitigate or obviate the aforementioned problems.

### SUMMARY OF THE INVENTION

The main objective of the present invention is to provide a manufacturing method for a hinge that comprises fewer components, is of a simplified structure and made by a simplified process, and lowers the cost.

The manufacturing method for a hinge in accordance with the present invention has steps of forming one of a central element and a surrounding by injection molding, cooling down the formed element, and forming the other element on the priorly-formed element by injection molding such that a limit segment of the surrounding element is mounted around and flush with the neck segment having a smallest width of the central element, which keeps the surrounding element from departing axially from the central element, and further reduces the number of the components and simplifies a structure of the hinge. Because a melting point of the element formed priorly is higher than a melting point of the element formed later, the element formed later does not attach to the priorly-formed element after being cooled down. Therefore, the two elements are relatively rotatable. Additionally, the central element and the surrounding element are respectively formed integratedly so the stability of the hinge is higher compared to a conventional hinge comprising so many components. Finally, because a manufacturing process of the hinge is accomplished after injection molding twice, the process of manufacturing the hinge is more convenient and faster, and the cost is lowered compared to the process of manufacturing a conventional hinge that involves much assembling work.

Other objectives, advantages and novel features of the invention will become more apparent from the following detailed description when taken in conjunction with the accompanying drawings.

### BRIEF DESCRIPTION OF THE DRAWINGS

FIG. 1 is a flow chart of a first embodiment of a manufacturing method for a hinge in accordance with the present invention;

FIG. 2 is a schematic view of the first step of the manufacturing method for a hinge in FIG. 1;

FIG. 3 is a front view of a hinge made by the manufacturing method for a hinge in FIG. 1;

FIG. 4 is a side view in partial section of a hinge made by the manufacturing method for a hinge in FIG. 1;

FIG. 5 is a schematic view of the third step of the manufacturing method for a hinge in FIG. 1;

FIG. 6 is an operational schematic view of a hinge made by the manufacturing method for a hinge in FIG. 1;

FIG. 7 is a perspective view of a hinge in another embodiment made by the manufacturing method for a hinge in accordance with the present invention;

FIG. 8 is a side view in partial section of the hinge in FIG. 7 made by the manufacturing method for a hinge in accordance with the present invention; and

FIG. 9 is a flow chart of a second embodiment of a manufacturing method for a hinge in accordance with the present invention.

### DETAILED DESCRIPTION OF THE PREFERRED EMBODIMENTS

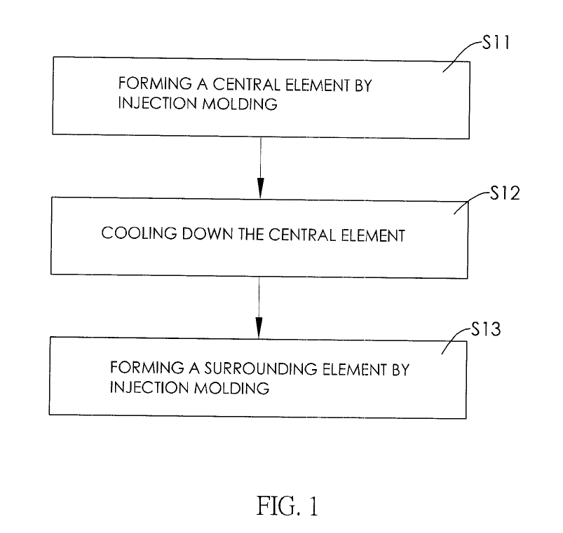

With reference to FIG. 1, a first embodiment of a manufacturing method for a hinge in accordance with the present invention comprises steps of forming a central element by injection molding (S11), cooling down the central element (S12), and forming a surrounding element by injection molding (S13).

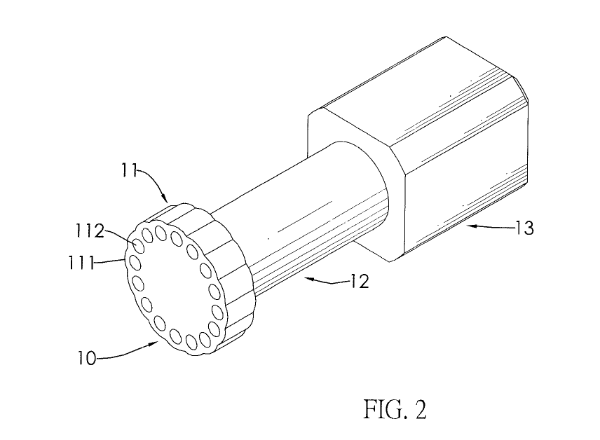

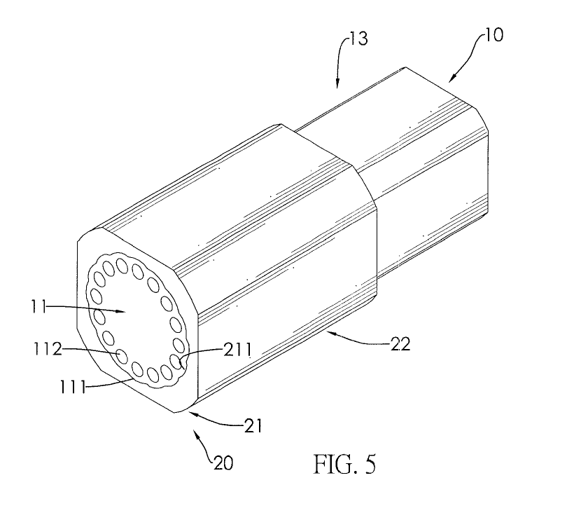

With reference to FIGS. 2 to 4, a central element 10 is formed by injection molding. The central element 10 has a mounting segment 11, a neck segment 12 and a fastening segment 13 formed axially in sequence. The neck segment 12 is circular in cross section. An outer diameter of the neck segment 12 is smaller than a width of the mounting segment 11 and a width of the fastening segment 13. In a preferred embodiment, the mounting segment 11 is circular in cross section. The mounting segment 11 has multiple positioning protrusions 111. The positioning protrusions 111 are formed on an outside wall of the mounting segment 11, and are arranged annularly. Each positioning protrusion 111 is curved. The mounting segment 11 has multiple compressing holes 112. The compressing holes 112 are formed through an end of the mounting segment 11, and are arranged annularly. A number of the compressing holes 112 is equal to a number of the positioning protrusions 111. Each compressing hole 112 is transversely inward relative to one of the positioning protrusions 111. The fastening segment 13 is substantially rectangular in cross section. The central element 10 is made of plastic material, and preferably the central element 10 is made of Polyphenylene sulfide (PPS).

After being formed by injection molding, the central element 10 is cooled down and solidified.

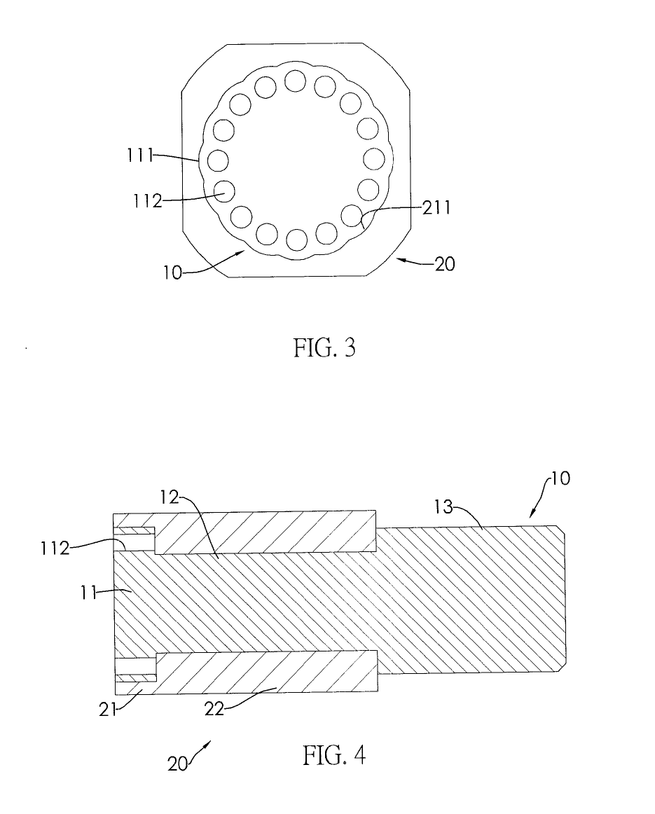

With reference to FIGS. 3 to 5, a surrounding element 20 is formed on the central element 10 by injection molding. The surrounding element 20 is mounted rotatably around the central element 10, and has a limit segment 22. The limit segment 22 is mounted around and is flush with the neck segment 12 of the central element 10. Two ends of the limit segment 22 respectively abut the mounting segment 11 and the fastening segment 13 of the central element 10. A melting point of the central element 10 is higher than a melting point of the surrounding element 20. In a preferred embodiment, the surrounding element 20 further comprises a positioning segment 21. The positioning segment 21 is formed on an end of the limit segment 22, and is mounted around and is flush with the mounting segment 11. The positioning segment 21 has multiple positioning recesses 211. The positioning recesses 211 are formed in an inside wall of the positioning segment 21, are arranged annularly, and selectively engage with the positioning protrusions 111. Each positioning recess 211 is curved. The material of the surrounding element 20 is plastic and is different from the material of the central element 10, and preferably the surrounding element 20 is made of Polyoxymethylene (POM).

In another embodiment, the surrounding element 20 is made of Polyphthalamide (PPA) and glass fiber, wherein a weight ratio of Polyphthalamide to glass fiber is 2 to 1. This material is a plastic material from EMS GRIVORY®, and the model number of the material is GV-5H.

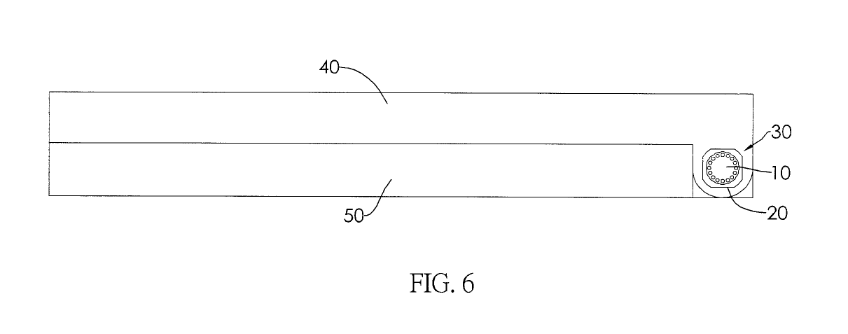

With reference to FIG. 6, the hinge 30 made by the manufacturing method in accordance with the present invention can be mounted on a flip device. The flip device further comprises a cover 40 and a base 50. The surrounding element 20 of the hinge 30 is securely mounted to the cover 40. The central element 10 of the hinge 30 is securely mounted on the base 50. In a preferred embodiment, the flip device has two hinges 30. The hinges 30 are respectively mounted on two sides on the back of the flip device. The central element 10 is mounted on the base 50 by the fastening segment. In another preferred embodiment, the flip device also can have only one hinge, and the hinge is mounted in the middle on the back of the flip device. In another preferred embodiment, in the flip device, the central element is securely mounted to the cover, and the surrounding element is securely mounted on the base. The flip device also can reach the same achievement.

The flip device may be portable electronic devices or other devices, such as notebook computers, or cosmetics boxes.

With reference to FIGS. 3, 4 and 6, when the flip device as described is used, the cover 40 is opened and pivoted relative to the base 50, and the surrounding element 20 is rotated relative to the central element 10 as well. In the rotation, the positioning recesses 211 of the surrounding element 20 press toward the positioning protrusions 111 of the central element 10, and the positioning protrusions 111 deform via the compressing hole 112 such that the positioning protrusions 111 can smoothly pass through the positioning recesses 211, which engage the positioning protrusions 111. When the external force on the cover 40 is removed, if tops of the positioning protrusions 111 do not abut against bottoms of the positioning recesses 211 precisely, which means the compressing holes 112 are still deformed, the compressing holes 112 press outward on the positioning protrusions 111 to be recovered. Therefore the positioning protrusions 111 are slightly rotated along a curved surface of the positioning recesses 211, until the tops of the positioning protrusions 111 abut against the bottoms of the positioning recesses 211 precisely. As a result, the cover 40 can be held at specific angles relative to the base 50, and the cover 40 will not lean or lie flat by the weight of the cover 40. Besides, the more positioning protrusions 111 and positioning recesses 211, the more specific angles the hinge 30 is able to maintain.

In the manufacturing method with the present invention, the central element 10 having a higher melting point is formed by injection molding, and then is cooled down. Afterwards, the surrounding element 20 is formed on the central element 10 by injection molding. Because the melting point of the surrounding element 20 is lower, the central element 10 is not melted when the surrounding element 20 wraps the central element 10 and is being formed by injection molding such that the surrounding element 20 is not attached to the central element 10 after being cooled down. Additionally, the mounting segment 11 and the neck segment 12 are circular in cross section, and an inside surface of the surrounding element 20 is mounted around and is flush with the mounting segment 11 and the neck segment 12. As a result, the inside surface of the surrounding element 20 is circular as well. Then the surrounding element 20 is rotatable relative to the central element 10. Besides, when the surrounding element 20 wraps the central element 10 and is being formed by injection molding, the material of the surrounding element 20 flows into and is mounted around the neck segment 12 of the central element 10 such that after the surrounding element 20 is cooled down and solidified, the limit segment 22, which wraps the neck segment 12, abuts axially the mounting segment 11 and the fastening segment 13, which are respectively on the two sides of the neck segment 12. As a result, the central element 10 is unable to move axially relative to the surrounding element 20. To sum up, after being formed by injection molding twice, the hinge 30 reaches the essential requirement of being rotatable relatively but being unable to move relatively.

Moreover, the central element 10 forms the positioning protrusions 111 and compressing holes 112 after being formed by injection molding, and the surrounding element 20 forms the positioning recesses 211 after being formed by injection molding again such that the hinge 30 further reaches the requirement of being held at multiple angles.

The manufacturing process of the hinge 30 is accomplished after injection molding twice, and the hinge 30 meets the requirements mentioned above at the same time. As a result, the hinge is convenient in manufacturing and is beneficial for mass production. The cost is lowered therefore.

Furthermore, the hinge 30 is made of plastic, which further lowers the cost. Finally, the hinge 30 is formed by injection molding, so the central element 10 and the surrounding element 20 are respectively formed integratedly to enhance the stability when in use.

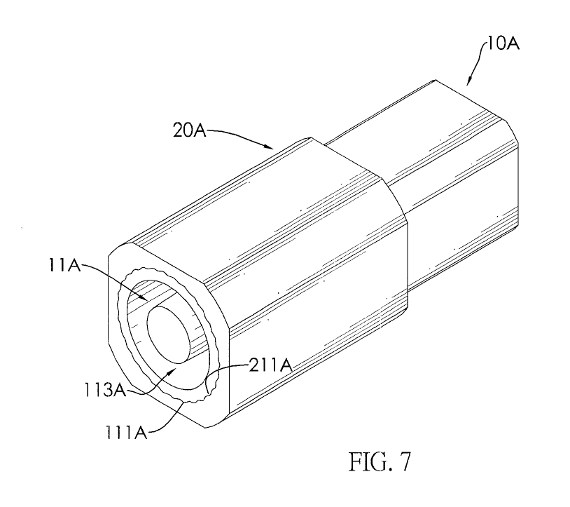

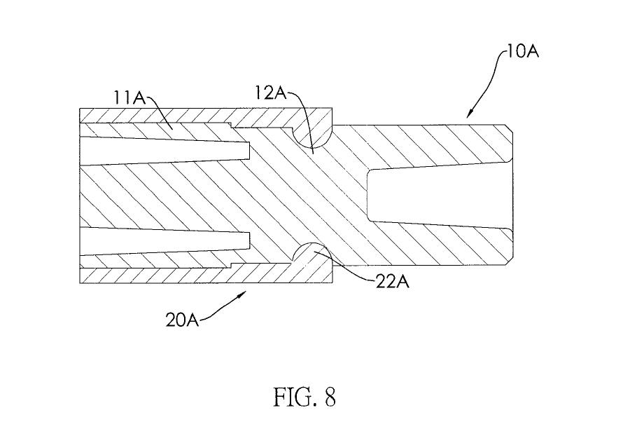

In another preferred embodiment as shown in FIGS. 7 and 8, in the step of forming a central element, the mounting segment 11A of the central element 10A has a compressing annular recess 113A formed in the end of the mounting segment 11A. The compressing annular recess 113A also provides a deforming space to the positioning protrusions 111A, so the positioning protrusions 111A can pass through the positioning recesses 211A more smoothly. Besides, a length of the neck segment 12A is shortened. With the limit segment 22A mounted around and flush with the neck segment 12A, the neck segment 12A can still keep the surrounding element 20A from departing axially from the central element 10A.

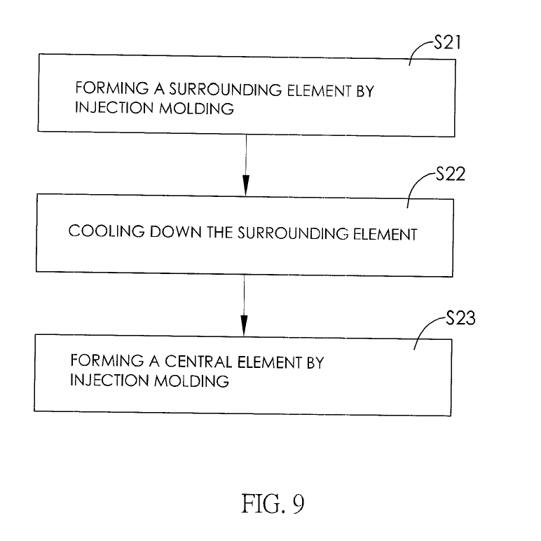

With reference to FIG. 9, a second embodiment of a manufacturing method for a hinge in accordance with the present invention comprises steps of forming a surrounding element by injection molding (S21), cooling down the surrounding element (S22), and forming a central element by injection molding (S23). The second embodiment is similar to the first embodiment, but the melting point of the surrounding element is higher than the melting point of the central element such that the surrounding element is formed first, and the central element is formed later. The hinge made by the second embodiment also has the advantages of the first embodiment.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A manufacturing method for a hinge comprising steps of:
forming a central element by injection molding, wherein the central element has a mounting segment, a neck segment and a fastening segment formed axially in sequence; the neck segment is circular in cross section; and an outer diameter of the neck segment is smaller than a width of the mounting segment and a width of the fastening segment;
cooling down and solidifying the central element; and
forming a surrounding element on the central element by injection molding, wherein the surrounding element is mounted rotatably around the central element, and has a limit segment mounted around and flush with the neck segment of the central element; two ends of the limit segment respectively abut the mounting segment and the fastening segment of the central element; a melting point of the central element is higher than a melting point of the surrounding element.

2. The manufacturing method for a hinge as claimed in claim 1, wherein
in the step of forming a central element, the mounting segment is circular in cross section; and
in the step of forming a surrounding element, the surrounding element further comprises a positioning segment formed on an end of the limit segment, and mounted around and flush with the mounting segment.

3. The manufacturing method for a hinge as claimed in claim 2, wherein
in the step of forming a central element, the mounting segment has multiple positioning protrusions formed on an outside wall of the mounting segment and arranged annularly; and
in the step of forming a surrounding element, the positioning segment has multiple positioning recesses formed in an inside wall of the positioning segment, arranged annularly, and selectively engaging with the positioning protrusions.

4. The manufacturing method for a hinge as claimed in claim 3, wherein
in the step of forming a central element, each positioning protrusion is curved; and
in the step of forming a surrounding element, each positioning recess is curved.

5. The manufacturing method for a hinge as claimed in claim 4, wherein in the step of forming a central element, the mounting segment of the central element has multiple compressing holes formed through an end of the mounting segment and arranged annularly.

6. The manufacturing method for a hinge as claimed in claim 5, wherein in the step of forming a central element, a number of the compressing holes is equal to a number of the positioning protrusions of the central element, and each compressing hole is transversely inward relative to one of the positioning protrusions.

7. The manufacturing method for a hinge as claimed in claim 4, wherein in the step of forming a central element, the mounting segment of the central element has a compressing annular recess formed in an end of the mounting segment.

8. The manufacturing method for a hinge as claimed in claim 6, wherein
in the step of forming a central element, the central element is made of plastic material; and
in the step of forming a surrounding element, the surrounding element is made of plastic material, wherein the material of the surrounding element is different from the material of the central element.

9. The manufacturing method for a hinge as claimed in claim 8, wherein
in the step of forming a central element, the central element is made of Polyphenylene sulfide (PPS); and
in the step of forming a surrounding element, the surrounding element is made of Polyoxymethylene (POM).

10. The manufacturing method for a hinge as claimed in claim 8, wherein
in the step of forming a central element, the central element is made of Polyphenylene sulfide (PPS); and
in the step of forming a surrounding element, the surrounding element is made of Polyphthalamide (PPA) and glass fiber, wherein a weight ratio of Polyphthalamide to glass fiber is 2 to 1.

11. A manufacturing method for a hinge comprising steps of:
forming a surrounding element by injection molding, wherein the surrounding element has a limit segment, and the limit segment is hollow;
cooling down and solidifying the surrounding element; and
forming a central element on the surrounding element by injection molding, wherein the central element is mounted rotatably in the surrounding element, and has a mounting segment, a neck segment and a fastening segment formed axially in sequence; the neck segment is circular in cross section, is mounted in and flush with the limit segment of the surrounding element; an outer diameter of the neck segment is smaller than a width of the mounting segment and a width of the fastening segment; the mounting segment and the fastening segment respectively abut two ends of the limit segment:, and a melting point of the surrounding element is higher than a melting point of the central element.

12. The manufacturing method for a hinge as claimed in claim 11, wherein
in the step of forming a surrounding element, the surrounding element further comprises a positioning segment formed on an end of the limit segment, and being hollow; and
in the step of forming a central element, the mounting segment of the central element is circular in cross section, is mounted in and flush with the positioning segment.

13. The manufacturing method for a hinge as claimed in claim 12, wherein
in the step of forming a surrounding element, the positioning segment has multiple positioning recesses formed in an inside wall of the positioning segment, and arranged annularly; and
in the step of forming a central element, the mounting segment has multiple positioning protrusions formed on an outside wall of the mounting segment, arranged annularly, and selectively engaging with the positioning recesses.

14. The manufacturing method for a hinge as claimed in claim 13, wherein
in the step of forming a surrounding element, each positioning recess is curved; and
in the step of forming a central element, each positioning protrusion is curved.

15. The manufacturing method for a hinge as claimed in claim 14, wherein in the step of forming a central element, the mounting segment of the central element has multiple compressing holes formed through an end of the mounting segment and arranged annularly.

16. The manufacturing method for a hinge as claimed in claim 15, wherein in the step of forming a central element, a number of the compressing holes is equal to a number of the positioning protrusions of the central element, and each compressing hole is transversely inward relative to one of the positioning protrusions.

17. The manufacturing method for a hinge as claimed in claim 14, wherein in the step of forming a central element, the mounting segment of the central element has a compressing annular recess formed in an end of the mounting segment.

18. The manufacturing method for a hinge as claimed in claim 16, wherein
in the step of forming a surrounding element, the surrounding element is made of plastic material; and
in the step of forming a central element, the central element is made of plastic material, wherein the material of the surrounding element is different from the material of the central element.

19. The manufacturing method for a hinge as claimed in claim 18, wherein
in the step of forming a surrounding element, the surrounding element is made of Polyphenylene sulfide (PPS); and
in the step of forming a central element, the central element is made of Polyoxymethylene (POM).

20. The manufacturing method for a hinge as claimed in claim 18, wherein
in the step of forming a surrounding element, the surrounding element is made of Polyphenylene sulfide (PPS); and
in the step of forming a central element, the central element is made of Polyphthalamide (PPA) and glass fiber, wherein a weight ratio of Polyphthalamide to glass fiber is 2 to 1.
